(19) United States
(12) Patent Application Publication
(10) Pub. No.: US 2018/0215029 A1
(43) Pub. Date: Aug. 2, 2018

(54) QUICK DOUBLE TRIGGER CONFIGURATION CHANGE

(71) Applicant: INGERSOLL-RAND COMPANY, Davidson, NC (US)

(72) Inventor: John P. Steckel, Bethlehem, PA (US)

(21) Appl. No.: 15/420,446

(22) Filed: Jan. 31, 2017

(51) Int. Cl. B25F 5/00; G01D 5/14; B25B 23/147

(52) U.S. Cl. CPC B25F 5/001; B25B 23/147; G01D 5/145

(57) ABSTRACT

A handheld power tool is provided that includes hand grip and output portions, and a control system. The output portion includes a rotating output shaft rotated by a motor when initiated by the trigger. The trigger includes multi-purpose functionality that initiates both rotation of the output shaft by the motor and change from one of a plurality of operating configurations of the output shaft to a new one of the plurality of operating configurations. The control system polls the trigger to detect multiple pull-and-release operations on the trigger to signal advancement of the plurality of operating configurations to the new one of the plurality of operating configurations. Multiple pull-and-release operations of the trigger changes to the new one of the plurality of operating configurations of the output shaft.

### TECHNICAL FIELD AND SUMMARY

The present disclosure relates to handheld power tools and, particularly, to handheld power tools having a double trigger pull to actuate various operating functions of the handheld power tool.

Handheld power tools commonly include a trigger that an operator may selectively depress to actuate the power tool. Advanced handheld power tools may also include predetermined operating configurations to assist an operator with various fastening and other like needs. The configurations are groupings of torque and speed settings. Target torque, shift down torque, free speed and shift down speed are examples of common settings. For clarity, shift down point is the torque at which speed changes from free speed to shift down speed. The tool may also control off of a target angle, rather than torque. The settings are grouped and stored in a configuration so that the configuration routine may be performed over and over again.

Such advanced power tools may also include an electronic display screen (e.g., liquid crystal display (LCD), an organic light emitting diode (OLED) display), and/or one or more separate indicator lights (e.g., LEDs) to serve as a human-machine interface. Typically, buttons associated with the electronic display screen change the operating configuration of the power tool as needed.

In certain circumstances, such as on an assembly line, there may be a need to install four or five different types of screws onto a product at a single station on that line. Each screw may have its own fastening speed and/or torque requirements. Traditionally, to perform these operations, four or five different power tools, each set to a particular configuration corresponding to each of the four or five screws, may be employed. The operator at the station may use a different power tool for each fastening operation.

Employing the more advanced power tools, the on-board buttons and LED screens allows the operator to set a single power tool to the individual four or five operating configurations needed. Under these circumstances, however, the operator may still use two hands—one to hold the tool and the other to press the button(s) to change the operating configuration. Obviously this takes time and might distract from the task at hand.

Accordingly, an illustrative embodiment of the present disclosure provides for a power tool that multi-purposes the single trigger that operates the rotating (i.e., fastening) function to also select the particular operating configuration of the power tool. In a further embodiment of the present disclosure, the trigger member of the power tool will be able to detect a multiple quick pull and release operation of the trigger to indicate the configuration of the power tool is to be changed rather than run the power tool. In a still further embodiment, a controller on the power tool may poll the trigger to detect multiple quick pull and release operations of the trigger member to signal advancement of the operating configuration to a new operating configuration. It is appreciated that in illustrative embodiments, successive quick double pull and release operations on the trigger may toggle the operating configuration of the power tool through multiple operating configurations until the desired operating configuration is reached.

An illustrative embodiment of the present disclosure provides a handheld power tool. This handheld power tool comprises hand grip and output portions, and a control system. The hand grip portion includes a handlegrip and a trigger movable with respect to the handlegrip. The output portion includes a rotating output shaft rotated by a motor when initiated by the trigger. The trigger includes multi-purpose functionality that initiates both rotation of the output shaft by the motor and change from one of a plurality of operating configurations of the output shaft to a new one of the plurality of operating configurations. The control system polls the trigger to detect multiple pull-and-release operations on the trigger to signal advancement of the plurality of operating configurations to the new one of the plurality of operating configurations. Multiple pull-and-release operations of the trigger changes to the new one of the plurality of operating configurations of the output shaft. The plurality of operating configurations is related to at least one of torque and speed of the output shaft. When the trigger is pulled and held the motor rotates the output shaft.

In the above and other embodiments, the handheld power tool may further comprise: an indicator visible on the exterior of the power tool that indicates each one of the plurality of operating configurations, wherein the indicator is selected from the group consisting of a plurality of lights and a display screen; the trigger being released during the pull-and-release operation polled by the control system occurs within about 0.5 seconds of the trigger being pulled; the trigger being pulled a second time within about 0.5 seconds after released during a second of the pull-and-release operation and released again within about 0.5 seconds of the trigger being pulled the second time, at which point the control system will change to the new one of the plurality of operating configurations of the output shaft; the plurality of operating configurations of the output shaft are selected from the group consisting of change in rotational speed of the output shaft and change in torque of the output shaft; successive multiple pull-and-release operations on the trigger toggles through successive operating configurations of the plurality of operating configurations of the power tool; a switch system operably engaged with the trigger and includes a linear Hall Effect sensor and an elongate trigger magnet having a first pole and a second pole, wherein the trigger magnet is mounted on the trigger such that the first pole is located proximate a rear end of the trigger and the second pole illustratively located proximate a front end of the trigger; wherein the linear Hall Effect sensor is electrically connected to the control system to detect the pull-and-release operation; the linear Hall Effect sensor being configured to provide a signal to the control system based on the pull-and-release operation; wherein the control system is configured to control a voltage applied to the motor; a switch system operably engaged with the trigger and includes a slide-by sensing configuration; wherein the slide-by configuration includes magnet that slides past a sensor in a direction from a first pole to a second pole during trigger depression, and in a direction from the second pole to the first pole during trigger release; wherein the sensor is electrically connected to the control system to detect the pull-and-release operation; the handgrip portion being located in-line with the output portion; and the handgrip portion being located about transverse to the output portion.

Another illustrative embodiment of the present disclosure provides a method of switching through a plurality of operational conditions of a handheld power tool. The method comprising the steps of: providing the handheld power tool that has a handlegrip and a trigger movable with respect to the handlegrip, and an output portion that includes a rotating output shaft rotated by a motor when initiated by the trigger; polling a sensor related to the trigger to determine if the trigger has been pulled; polling the sensor related to the trigger to determine if the trigger has been released after being pulled within a predefined period of time; operating the motor if the trigger was not released within the predetermined period of time; polling the sensor related to the trigger to determine if the trigger has been pulled a second time within a second predetermined period of time; polling the sensor related to the trigger to determine if the trigger has been released after being pulled the second time within a third predefined period of time; and switching to a new operating condition of the plurality of operational conditions if the trigger was released within the third predetermined period of time.

In the above and other embodiments, the method of switching through a plurality of operational conditions of the handheld power tool may further comprise: polling multiple, successive, trigger pulls-and-releases to advance to successive new operational configurations of the plurality of operational configurations without operating the motor; wherein the predetermined period of time is about 0.5 seconds; and wherein the second and third predetermined periods of time is each about 0.5 seconds.

Additional features of the present disclosure will become apparent to those skilled in the art upon considering the following description exemplifying the disclosure as presently perceived.

### BRIEF DESCRIPTION OF THE DRAWINGS

The present disclosure will be described hereafter with reference to the attached drawings which are given as non-limiting examples.

FIG. 1 is a perspective view of a handheld power tool according to embodiments of the present disclosure;

FIG. 2 is a rear perspective view of the handheld power tool of FIG. 1;

FIG. 3 is an enlarged, fragmentary, left-side view of the handheld power tool of FIG. 1;

FIG. 4 is a schematic electrical diagram of the handheld power tool of FIG. 1;

FIG. 5 is an illustrative flow chart disclosing an illustrative process of the trigger member quick pull operation;

FIG. 6 is an illustrative flow chart disclosing the process of advancing to successive configuration modes; and

FIG. 7 is a perspective view of another illustrative embodiment of a power tool according to the present disclosure.

Corresponding reference characters indicate corresponding parts throughout the several views. The exemplification set out herein illustrates various embodiments of the disclosure, and such exemplification is not to be construed as limiting the scope of the disclosure in any manner.

### DETAILED DESCRIPTION OF THE DRAWINGS

The figures and descriptions provided herein may have been simplified to illustrate aspects that are relevant for a clear understanding of the herein described structures, while eliminating, for the purpose of clarity, other aspects that may be found in typical structures. Those of ordinary skill may recognize that other elements and/or operations may be desirable and/or necessary to implement the structures described herein. Because such elements and operations would be known in the art, and because they do not facilitate a better understanding of the present disclosure, a discussion of such elements and operations may not be provided herein. The present disclosure, however, is deemed to inherently include all such elements, variations, and modifications to the described aspects that would be known to those of ordinary skill in the art.

Unless otherwise defined, the term “cordless” power tool refers to power tools that do not require plug-in, hard wired electrical connections to an external power source to operate. Rather, the cordless power tools have electric motors that are powered by on-board batteries, such as rechargeable batteries. A range of batteries may fit a range of cordless tools. Different cordless power tools may have a variety of electrical current demand profiles that operate more efficiently with batteries providing a suitable range of voltages and current capacities. The different cordless (e.g., battery powered) power tools may include, for example, screwdrivers, ratchets, nutrunners, impact tools and the like, including the tools of the present disclosure.

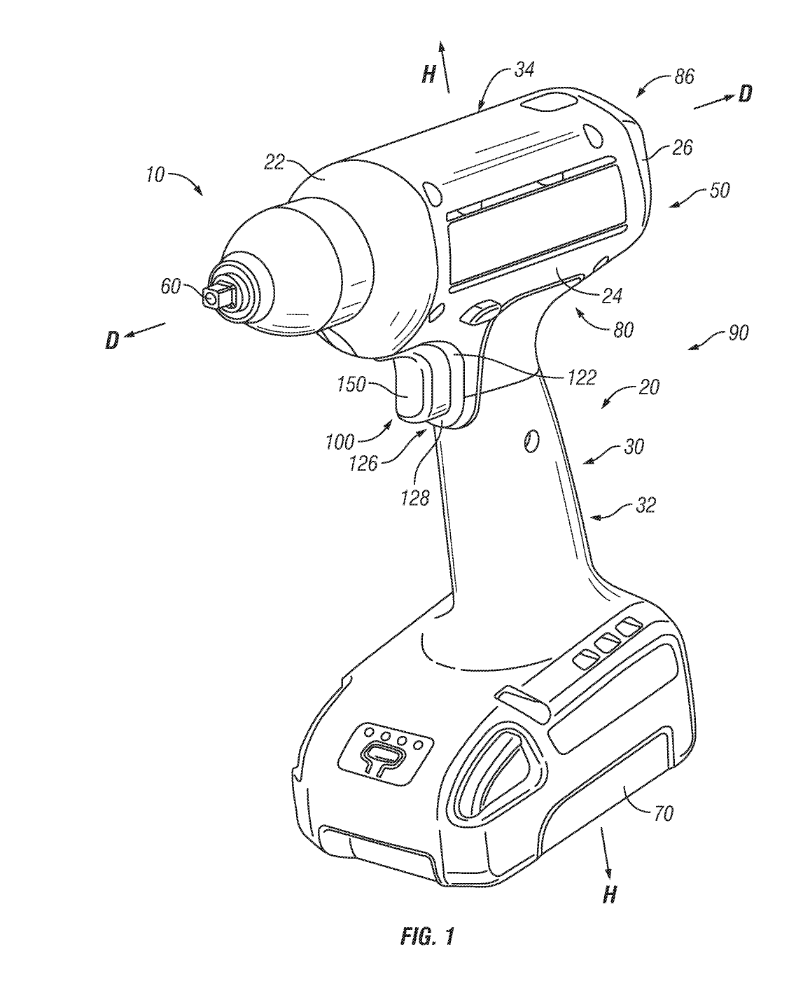

A front perspective view of an illustrative embodiment of power tool 10 is shown in FIG. 1. Handheld power tool 10 includes a trigger system 100 according to embodiments of the present disclosure. Power tool 10 may be any suitable type of handheld power tool and, according to some embodiments is an electrically powered and/or cordless handheld power tool. In other embodiments, power tool 10 may be powered by electricity supplied through an attached cord. Power tool 10 further includes a protective housing assembly 20, a drive motor assembly 50, a tool output shaft or drive head 60, a battery pack 70, and a control system 80. Housing assembly 20 includes a housing 30 having an upper or main body portion 34 and a pistol grip or handle 32 depending therefrom. Housing 30 is formed by a right shell or housing member 22 and a left shell or housing member 24. Housing assembly 20 further includes a rear cover or protective display housing 26. Handle 32 illustratively includes a pistol grip form factor, configured to be grasped and held while power tool 10 is in use (i.e., when applying a force using the drive motor assembly 50 inside housing assembly 20) in the manner of a pistol grip.

A trigger member 150 forming a part of trigger system 100 is located on a front side of the handle 32 such that the operator's finger (e.g., index finger) may be positioned proximate trigger member 150 when the operator is holding handle 32. Handle 32 defines a heightwise axis H-H. In the case of pistol grip handle 32, an operator will ordinarily wrap his or her fingers around the heightwise axis H-H.

Rotary drive head 60 may define a tool drive axis D-D (e.g., the axis of rotation of rotary drive head 60) that is transverse to (and intersects) heightwise axis H-H. According to some embodiments, axes D-D and H-H form an angle in the range of from about 70 degrees to about 90 degrees. Right housing member 22 and left housing member 24 may be formed of any suitable material(s) or compositions(s). According to some embodiments, the entirety of each housing member 22, 24 are formed of the same material or composition. According to some embodiments, housing members 22, 24 are formed of a polymeric material. According to some embodiments, the housing members 22, 24 are formed of glass-filled nylon.

Drive motor assembly 50 and battery pack 70 are contained in or attached to housing 30. In an illustrative embodiment, motor assembly 50 is contained in the upper chamber or main body 34, and battery pack 70 is releasably mounted on the lower end of handle 32. Construction and operation of drive motor assemblies and battery packs in handheld power tools are well known to those of skill in the art and will not be discussed in detail herein. Drive motor assembly 50 may include an electric motor 52 arranged and configured (directly or via a gear case, linkage or gear system) to selectively drive (e.g., rotate) drive head 60 using power supplied from battery pack 70. Illustratively, motor 52 is a DC electric motor.

An illustrative embodiment of the present disclosure provides for different torque and speed operating configurations to be selected by depressing trigger member 150 in a particular manner. Illustratively, trigger system 100 is configured so that if trigger member 150 is depressed and held, drive motor 50 in power tool 10 rotates. But trigger system 100 may be further configured to poll for a trigger pull that is then released quickly, illustratively within about 0.5 seconds from pulling it. Trigger member 150 may then be polled a second time to determine if it was pulled and released within about 0.5 seconds. If trigger member 150 has been quickly pulled and released twice in a row then trigger system 100 is configured to send a signal to control system 80 located in power tool 10 to cause drive motor assembly 50 to change rotational speed and/or torque to a new predefined configuration such as faster, slower and/or greater or lower torque to match the necessary operational parameters of the fastener or other object being rotated. This allows the operational configuration of power tool 10 to be changed by simply double pull and releasing the trigger member at a common location the operator will already have his or her finger. This is contrast to depressing other buttons or other activation means on the tool that may be cumbersome or relatively time consuming to operate in order to change the operational configuration of the tool.

In another illustrative embodiment, not only can trigger member 150 be polled for trigger pull to determine if it was twice pulled and released to change to the next operational configuration but also be polled again to switch power tool 10 to still another operational configuration. Further illustratively, trigger system 100 may be configured to allow the operator to cycle through several different preset operating configurations for power tool 10 simply by twice pull and release trigger member 150 multiple times until the desired operating configuration is reached. The different operating conditions may include pre-set values, such as torque, speed, shift down speed, shift down point, angle, etc. This allows the operator to keep his or her hand on pistol grip 32 and finger on trigger member 150 while being able to both run power tool 10 and change its operating configuration mode. The display screen may display the configuration number which it has moved to, either briefly or permanently. In an illustrative embodiment, there may be available LEDs outside of the screen—read, yellow, green, blue, for example. These may be configured to flash a certain number of times to tell the user which configuration number the tool was set to, or cycle through a pattern to indicate that the new configuration input was received.

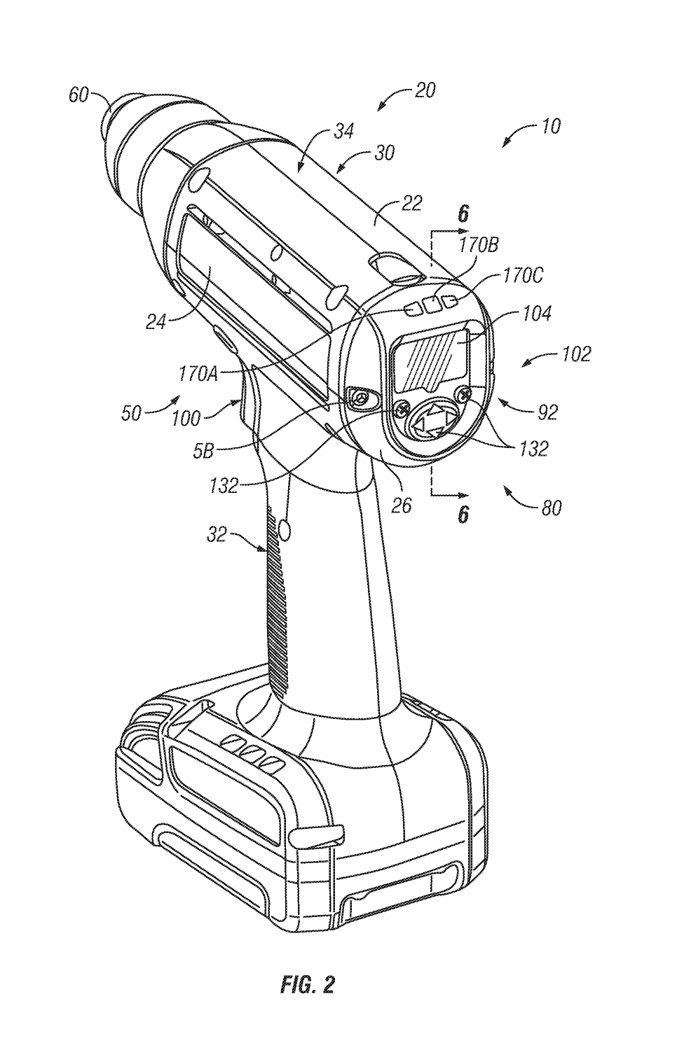

A rear perspective view of power tool 10 is shown in FIG. 2. Power tool 10 further shows housing assembly 20, a drive motor assembly 50, tool output shaft or drive head 60, battery pack 70, control system 80, and a display assembly or module 102. Additionally, this view depicts housing assembly 20 which includes housing 30, upper or main body portion 34 with pistol grip 32 depending therefrom, and right and left housing members 22 and 24, respectively. Also shown in this view with respect to housing assembly 20 is protective display housing 26 which also foul's a part of the display module 102. Display module 102 further includes a human-machine interface (HMI) 92 with display screen 104. Illustratively part of display module 102 are integral lens member 104 and a plurality of upper light pipe portions 170A, 170B, 170C.

In use, HMI 92 may be used in known or any suitable manner by the operator to input commands to control system 80 and/or to display data from the control system 80 to the operator. These structures help indicate to the operator the current operating condition of power tool 10 as well as changing its operating condition. Illustratively, buttons 132 may be manipulated to input commands. Data may be displayed as indicia on the display screen 104 viewable by the operator. Fastener 5B illustratively attaches display module 102 to housing 30.

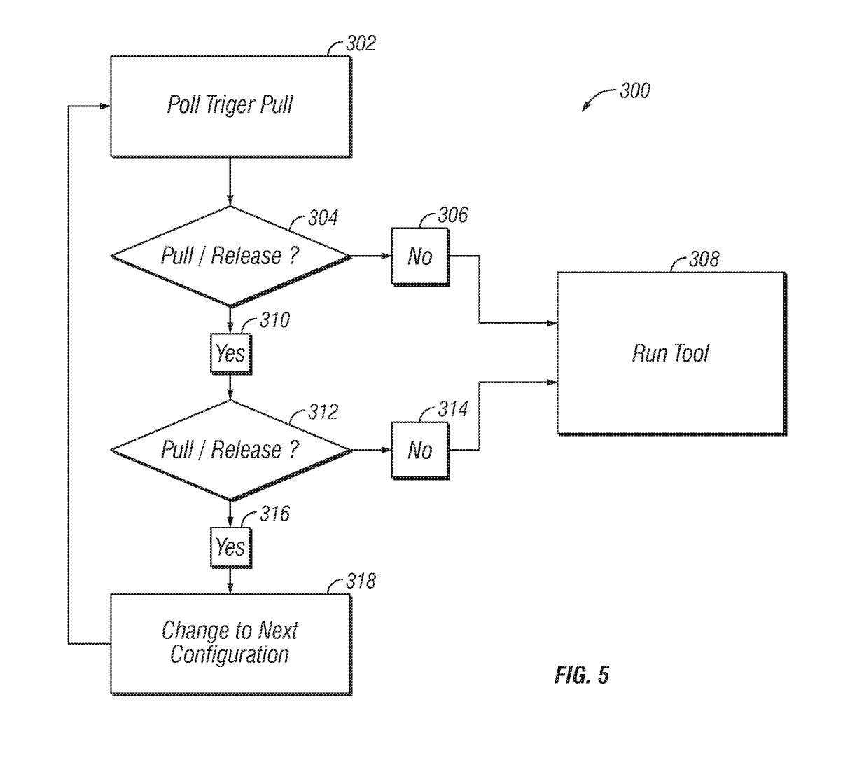

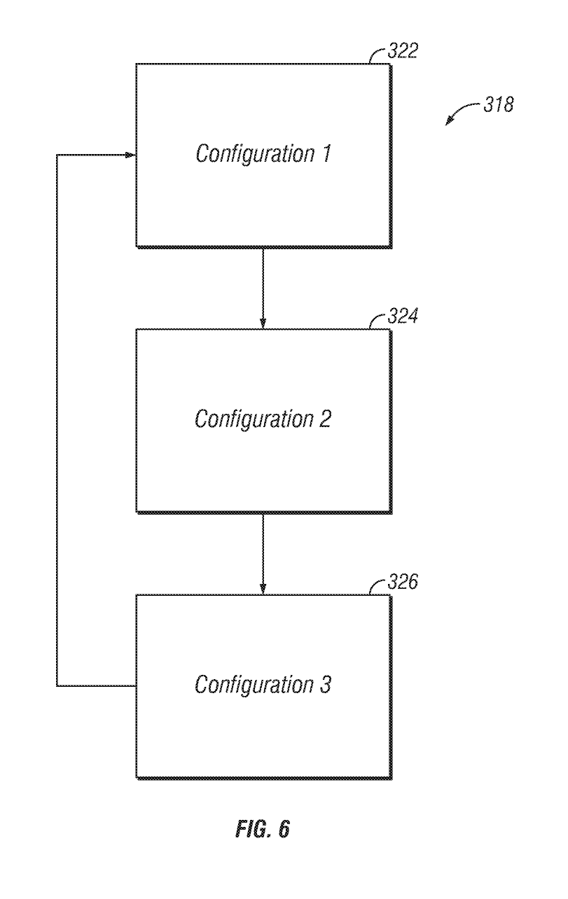

Although effective, under certain operating environments power tool 10 may experience, the operator may be wearing gloves or may otherwise be in a position where actuating buttons 132 is inconvenient. Accordingly, the quick double pull/release of trigger member 150 may be a more convenient way to change operating configurations of power tool 10 as an alternative to operating buttons 132. It is further appreciated that display screen 104 or even light pipe portions 170A, 170B, 170C, may be set to display current configuration modes set by double pulling trigger member 150. It will become clear to the skilled artisan upon reading this disclosure that by providing configuration mode selection through successive double pull/releases of trigger member 150, either alone or in combination with configuration indicators via display screen 104 and/or light pipe portions 170A, 170B, 170C, for example, the operator may now switch through one or more operating configuration modes using just one hand, and confirming changes to said configuration mode through visual inspection of the rear (or other portions) of power tool 10. (See, also, FIGS. 5 and 6.)

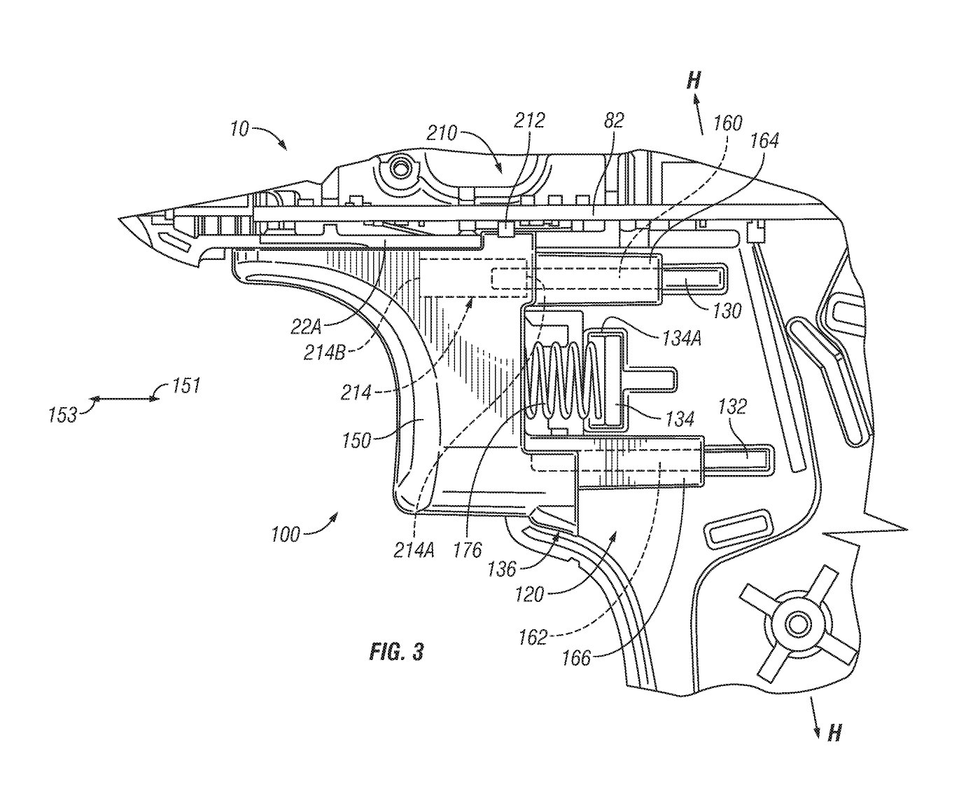

An enlarged, fragmentary, left side view of trigger member 150 and associated components of power tool 10 are shown in FIG. 3. It is appreciated from this view that trigger member 150 is configured to be depressed in direction 151 and then released to return back in direction 153 to its original undepressed condition. Particularly, this view shows upper linear guide features 130, 160 and lower linear guide features 132, 162 spaced apart along the heightwise axis H-H (e.g., vertically stacked) illustratively limiting trigger member 150 to a linear slide path relative to housing assembly 20 as previously described in U.S. patent application Ser. Nos. 14/023057 and 14/004104, the disclosures of which are hereby incorporated in their entirety by reference.

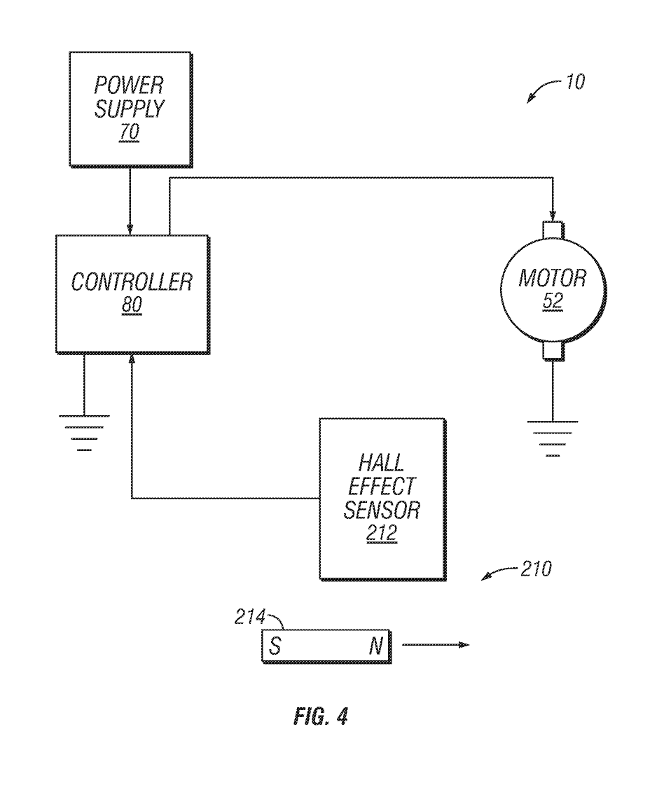

Power tool 10 includes illustrative control system 80 with switch system 210 shown diagrammatically in FIG. 4. Switch system 210 includes a linear Hall Effect sensor 212 and an elongate trigger magnet 214 (e.g., a permanent magnet). Trigger magnet 214 is mounted in trigger member 150 such that one pole 214A (e.g., the North pole) thereof is located proximate the rear end of trigger member 150 and the opposed pole 214B (e.g., the South pole) thereof, and as also shown in FIG. 3, is illustratively located proximate the front end of the trigger member 150. Linear Hall Effect sensor 212 is electrically connected to control system 80. Sensor 212 may be mounted on a PCB assembly 82. Control system 80 may be a microcontroller including PWM circuitry configured to generate a variable PWM voltage duty cycle. Sensor 212 is configured to provide a reference signal or sensor output signal to the control system 80. Control system 80 is also configured to control the power or voltage applied to the motor 52 dependent on or as a function of the received sensor output voltage from the linear Hall Effect sensor 212.

According to illustrative embodiments, control system 80 as shown in FIG. 4, may configured such that the magnetic flux density applied to sensor 212 varies from a minimum to a maximum value, or from a maximum to a minimum value, as the trigger member 150 is displaced from its fully extended position to its fully depressed position. According to some embodiments, switch system 210 is configured in a slide-by sensing configuration or arrangement. In the slide-by configuration, magnet 214 physically slides past the sensor 212 in a direction from pole 214A to pole 214B (during trigger depression) and in a direction from pole 214B to 214A (during trigger release or extension). In some embodiments, sensor 212 may be positioned proximate the pole 214A and distal from the pole 214B when the trigger member 150 is in its extended position (as shown in FIG. 3) and is positioned proximate pole 214B and distal from the pole 214A when the trigger member 150 is in its fully retracted or depressed position. This configuration may provide a more linear relative displacement to output voltage response. However, other sensor/magnet configurations may be used, such as a head-on sensing configuration (wherein one pole of the magnet is moved with respect to the sensor without sliding the magnet past the sensor), a push-pull configuration (wherein two opposed, complementary magnets are mounted on trigger member 150 and slide past sensor 212), or a push-push configuration (wherein two opposed magnets with opposing fields are mounted on the trigger member 150 and slide past the sensor 212). In some embodiments, the variable output signal or voltage provided by the Hall Effect sensor 212 is substantially linearly proportional to the magnetic field applied thereto. Power tool 10 according to some embodiments may include switch systems using a Hall Effect sensor providing a variable output signal as described that is not substantially linearly proportional to the applied magnetic field strength, but may instead be otherwise proportional (e.g., logarithmically proportional) to the applied magnetic field strength. In some embodiments, the Hall Effect sensor incorporates hysteresis (e.g., using a Schmitt trigger). The signals generated from moving trigger member 150 past the hall effect sensor are communicated to controller 80 and are then interpreted using software code logic to advance the configuration to the next in the sequence.

Incorporating the operation of trigger member 150 with control system 80, an illustrative double pull/release operation to switch operating configurations may be implemented. Such a system 300 is shown in the flow chart depicted in FIG. 5. The first step is to poll for trigger pull as indicated at 302. Control system 80 periodically checks if the hall sensor condition was pulled. If a trigger pull is detected, system 300 determines whether trigger member 150 was pulled and released within a certain time period such as 0.5 seconds. It is appreciated that the time gap between depressed and released trigger member 150 may be adjusted as needed to create a desired press and release effect. That said, if trigger member 150 was not released within the predetermined time period, as indicated at 306, then controller 80 will operate motor 52 to run power tool 10 pursuant normal operation. Conversely, if the pull and release at 304 occurs within the designated time period as indicated at 310, system 300 polls to determine if a second pull and release operation against trigger member 150 occurs as indicated at 312. If the answer is no as indicated at 314, either nothing happens if the trigger member 150 is released slowly or power tool 10 runs pursuant normal operation if trigger member 150 is held in the depressed position. If, however, polling trigger member 150 detects the pull and release condition within the predetermined time period as indicated at 316, control system 80 will change the tool's operational settings according to the next predefined configuration number as indicated at 318. In other words, system 300 detects multiple, successive, and quick trigger pulls and releases. And when this happens, system 80 advances the operational configuration of power tool 10 to the next predefined torque and/or speed setting. As a skilled artisan will understand upon reading the disclosure herein, although this example in FIG. 5 demonstrates a double quick pull/release operation, it is appreciated that in other embodiments the quick pull/release may occur more than twice in order to achieve the configuration change, as needed for the particular tool.

When switching configurations such as those configurations recited above and as indicated at 318 in FIG. 5, those configurations may be cycled through via multiple successive double trigger pulls. Such cycling is shown by the flow chart in FIG. 6. For example, power tool 10 may initially be set at configuration 1 and upon depression and holding of trigger member 150, power tool 10 will operate according to its designated configuration such as configuration 1 at 322. Upon detection of two successive pull and release operations on trigger member 150, as indicated at 304 and 312 of FIG. 5, controller 80 switches from operating configuration 1 at 322 to configuration 2 at 324. Power tool 10 is now operable at this configuration 2 when trigger member 150 is depressed and held. That said, upon another detection of multiple pull and release operations 304 and 312 controller 80 will switch the operating configuration from configuration 2 at 324 to configuration 3 at 326. Now power tool 10 may be run at configuration 3 when trigger member 150 is subsequently depressed and held.

In an illustrative embodiment, it is appreciated that the number of potential configuration options may vary. For example, depending on the needs for power tool 10, this double trigger pull can toggle between just first and second configurations or toggle through more than three distinct operating configurations. In a further illustrative embodiment, power tool 10 may have eight pre-programmed operating configurations that can be cycled through and used before repeating configuration 1 again. Additionally, it may not be required that power tool 10 has operated in the current configuration before advancing to the next configuration. For example, a double trigger pull and release (such as 304 and 312) may illustratively advance power tool 10 from configuration 1 to configuration 2. But controller 80 can poll an immediate subsequent pull and release operation (304 and 312) to advance to the next configuration rather than run at the current configuration. For example, power tool 10 may be currently set at configuration 2 at 324 and detect two successive sets of double pull and release functions 304 and 312 to advance the operating configuration of power tool 10 past configuration 3 and to configuration 1 without any intermediary operation of power tool 10.

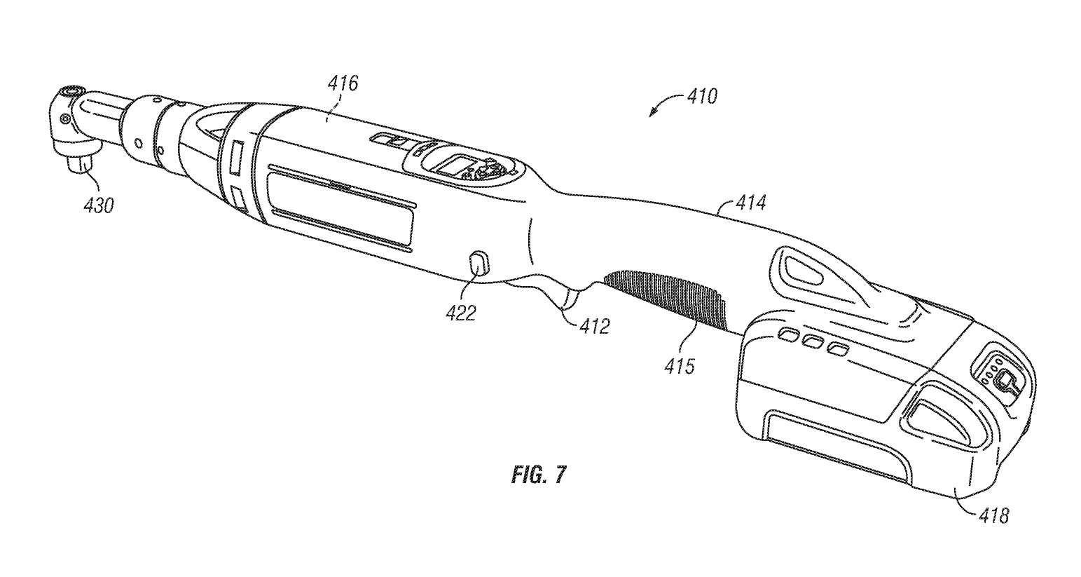

Another illustrative embodiment of a power tool 410 having a primary switch 412 and a reconfigurable secondary switch 422 is shown in FIG. 7. Such a power tool is also disclosed in U.S. patent application Ser. No. 14/184,943, the disclosure of which is hereby incorporated in its entirety by reference. Primary switch 412 is coupled to a housing 414 of power tool 410 and is configured to control a supply of energy to a motor 416 supported in the housing 414. Particularly, primary switch 412 is embodied as a trigger positioned near handle portion 415 of housing 414. Here, handle portion 415 is in-line with both battery 418 and motor 416. It will be appreciated that, in other embodiments, primary switch 412 may be embodied as any other suitable type of user input device and/or may be positioned in any other suitable location on housing 414. Inclusion of this embodiment will allow the skilled artisan upon reading this disclosure to understand that the double quick pull and release operation as described with respect to power tool 10 may be employed in power tools of alternate configuration. In other words, although power tool 410 is illustratively shown as a right angle wrench in FIG. 7, it is contemplated that the concepts of the present disclosure may be incorporated into a variety of other power tools.

When the operator activates primary switch 412 (e.g., depresses the trigger 412), primary switch 412 connects motor 416 to the energy source such as battery 418 coupled to power tool 410 to supply energy to motor 416. The supply of energy to motor 416 will cause rotation of a rotor of motor 416, thereby driving an output 430 of (for instance, via a drive train included in the power tool 10).

It is appreciated that in certain embodiments, the quick pull and release operation may be employed in power tools that include a secondary switch in order to operate. In the illustrative embodiment, secondary switch 422 may slide from side-to-side such that portions of the secondary switch 422 pass through apertures formed in the side walls of the housing 414. Secondary switch 422 or other like structure may be required to be depressed before primary switch 412 will activate to run motor 416. It is appreciated that the quick pull and release operation may be configured to switch between configurations (as previously discussed) without the need to depress secondary switch 422, or only upon depression of secondary switch 422 depending on how power tool 410 is needed to operate.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure.

1. A handheld power tool comprising:
a hand grip portion having a handlegrip and a trigger movable with respect to the handlegrip;
an output portion that includes a rotating output shaft rotated by a motor when initiated by the trigger;
wherein the trigger includes multi-purpose functionality that initiates both rotation of the output shaft by the motor and change from one of a plurality of operating configurations of the output shaft to a new one of the plurality of operating configurations;
a control system that polls the trigger to detect multiple pull-and-release operations on the trigger to signal advancement of the plurality of operating configurations to the new one of the plurality of operating configurations;
wherein a multiple pull-and-release operation of the trigger changes to the new one of the plurality of operating configurations of the output shaft;
wherein the plurality of operating configurations is related to at least one of torque and speed of the output shaft; and
wherein when the trigger is pulled and held the motor rotates the output shaft.

2. The handheld power tool of claim 1, further comprising an indicator visible on the exterior of the power tool that indicates each one of the plurality of operating configurations, wherein the indicator is selected from the group consisting of a plurality of lights and a display screen.

3. The handheld power tool of claim 1, wherein the trigger is released during the pull-and-release operation polled by the control system occurs within about 0.5 seconds of the trigger being pulled.

4. The handheld power tool of claim 3, wherein the trigger is pulled a second time within about 0.5 seconds after released during a second of the pull-and-release operation and released again within about 0.5 seconds of the trigger being pulled the second time at which point the control system will change to the new one of the plurality of operating configurations of the output shaft.

5. The handheld power tool of claim 1, wherein the plurality of operating configurations of the output shaft are selected from the group consisting of change in rotational speed of the output shaft and change in torque of the output shaft.

6. The handheld power tool of claim 4, wherein successive multiple pull-and-release operations on the trigger toggles through successive operating configurations of the plurality of operating configurations of the power tool.

7. The handheld power tool of claim 1, further comprising a switch system operably engaged with the trigger and includes a linear Hall Effect sensor and an elongate trigger magnet having a first pole and a second pole, wherein the trigger magnet is mounted on the trigger such that the first pole is located proximate a rear end of the trigger and the second pole illustratively located proximate a front end of the trigger; wherein the linear Hall Effect sensor is electrically connected to the control system to detect the pull-and-release operation.

8. The handheld power tool of claim 7, wherein the linear Hall Effect sensor is configured to provide a signal to the control system based on the pull-and-release operation. wherein the control system is configured to control a voltage applied to the motor.

9. The handheld power tool of claim 1, further comprising a switch system operably engaged with the trigger and includes a slide-by sensing configuration, wherein the slide-by configuration includes magnet that slides past a sensor in a direction from a first pole to a second pole during trigger depression, and in a direction from the second pole to the first pole during trigger release, wherein the sensor is electrically connected to the control system to detect the pull-and-release operation.

10. The handheld power tool of claim 1, wherein the handgrip portion is located in-line with the output portion.

11. The handheld power tool of claim 1, wherein the handgrip portion is located about transverse to the output portion.

12. A method of switching through a plurality of operational conditions of a handheld power tool, the method comprising the steps of:
providing the handheld power tool that has a handlegrip and a trigger movable with respect to the handlegrip, and an output portion that includes a rotating output shaft rotated by a motor when initiated by the trigger;
polling a sensor related to the trigger to determine if the trigger has been pulled;
polling the sensor related to the trigger to determine if the trigger has been released after being pulled within a predefined period of time;
operating the motor if the trigger was not released within the predetermined period of time;
polling the sensor related to the trigger to determine if the trigger has been pulled a second time within a second predetermined period of time;
polling the sensor related to the trigger to determine if the trigger has been released after being pulled the second time within a third predefined period of time; and
switching to a new operating condition of the plurality of operational conditions if the trigger was released within the third predetermined period of time.

13. The method of claim 12, further comprising the steps of polling multiple, successive, trigger pulls-and-releases to advance to successive new operational configurations of the plurality of operational configurations without operating the motor.

14. The method of claim 12, wherein the predetermined period of time is about 0.5 seconds.

15. The method of claim 12, wherein the second and third predetermined periods of time is each about 0.5 seconds.
